(19) United States
(12) Patent Application Publication
(10) Pub. No.: US 2019/0268662 A1
(43) Pub. Date: Aug. 29, 2019

(54) SYSTEM AND METHOD FOR ENHANCING LIVE VIDEO CONTENT STREAMS

(71) Applicant: Microsoft Technology Licensing, LLC, Redmond, WA (US)

(72) Inventors: Gershom L. Payzer, Redmond, WA (US); Matthew Wan, Redmond, WA (US); Gary Waliczek, Seattle, WA (US); Joseph M.R. Blouin, Redmond, WA (US)

(21) Appl. No.: 15/906,104

(22) Filed: Feb. 27, 2018

(51) Int. Cl. H04N 21/4784; H04N 21/442; G06Q 30/02

(52) U.S. Cl. CPC H04N 21/4784; G06Q 30/0235; G06Q 30/0231; H04N 21/44204

(57) ABSTRACT

Content streams are enhanced through management of spectator tracking and reward determinations via a central system between a streamer client device and spectator client devices. Spectators viewing a content stream of a title streamed over a network via a title rewards service from the client device executing the title are tracked along with their time spent viewing the stream. An indication of a reward received from the streamer client device causes the title rewards service to determine spectators meeting reward criteria and issues a multi-cast reward notice to qualified spectator client devices. Spectators authenticate with the title rewards service as players of titles to redeem rewards that are provided by the titles at their client devices. Spectators of unintegrated titles are also tracked for later rewards when such titles are integrated into the title rewards service.

### BACKGROUND

Client devices, such as gaming consoles, personal computers, and handheld devices, may provide capabilities to stream content of a user playing a title (e.g., a game or game client developed and/or published by a developer). Spectators may then be allowed to view the stream in real-time as the title is being played by the user. During the content streaming, rewards for spectators may be granted based on various viewing criteria.

For titles to provide streaming rewards, title developers create web services for their specific titles. A title developer receives an event stream from their web service that contains spectator watching behavior for each spectator. When a user playing the title being streamed triggers criteria defined for the title by the developer, the user playing the streaming title receives a notification to grant the reward in-game from the web service. The developer's web service (i.e., a title service) has to be scaled sufficiently to handle all individual spectator unlocks for rewards as a real-time stream, and the developer bears the monetary cost of doing so. The title service is notified, on a per-spectator basis, that spectators are viewing content of a streamed title, and the title service issues individual communications to each spectator for redeeming rewards. The title service also tracks the title state during game play in order to appropriately issue rewards, and maintains a durable storage for all of this information that the game client can query for rewards after they have been granted. Additionally, users and spectators have to authenticate individually with each title developer that implements such web services, sharing their account information in the process. The title developer has to make significant investment to track and determine rewards for common title scenarios.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods for enhancing live video content streams and rewards management are performed by systems and apparatuses. Users may play titles (e.g., video games of one or more developers) at client devices that execute the titles. Large numbers of spectators may view live video content streams of those titles being played that are streamed from those client devices to the spectators' own client devices. Rewards may be issued by the executing title for spectators meeting viewing criteria. Accordingly, management of spectator viewing and participation for the granting of rewards is performed herein. For instance, content streams and rewards issuing are enhanced through management of spectator tracking and reward determinations via a central system. The central system is communicatively situated between a streamer client device and spectator client devices. The streamer client device streams a content stream of a title over a network. Spectators viewing the content stream are tracked along with their time spent viewing. An indication of a reward received from the streamer client device causes a title rewards service at the central system to determine spectators meeting reward criteria and issues a multi-cast reward notice to qualified spectator client devices. Spectators may authenticate with the title rewards service as players of titles to redeem rewards that are provided by the titles. Spectators of unintegrated titles are also tracked for later rewards when such titles are integrated into the title rewards service.

Further features and advantages, as well as the structure and operation of various examples, are described in detail below with reference to the accompanying drawings. It is noted that the ideas and techniques are not limited to the specific examples described herein. Such examples are presented herein for illustrative purposes only. Additional examples will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of a networked system for enhancing live video content streams and managing rewards, according to an example embodiment.

FIG. 2 shows a block diagram of a reward service host system for enhancing live video content streams and managing rewards, according to an example embodiment

FIG. 3 shows a flowchart for enhancing live video content streams and managing rewards, in accordance with an example embodiment.

FIG. 4 shows a flowchart for issuing notification of stored rewards to a spectator, in accordance with an example embodiment.

FIG. 5 shows a flow diagram for enhancing live video content streams and managing rewards, in accordance with an example embodiment.

FIG. 6 shows a block diagram of a title management subsystem for managing title and rewards information, in accordance with an example embodiment.

FIG. 7 shows a flowchart for integrating titles and determining retroactive rewards with regard to the same, in accordance with an example embodiment.

FIG. 8 shows a block diagram of a client system configured for spectating and streaming of titles, in accordance with an example embodiment.

FIG. 9 shows a block diagram of an example mobile device that may be used to implement various example embodiments.

FIG. 10 shows a block diagram of an example computing device that may be used to implement embodiments.

The features and advantages of embodiments will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The following detailed description discloses numerous embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the discussion, unless otherwise stated, adjectives such as “substantially,” “approximately,” and “about” modifying a condition or relationship characteristic of a feature or features of an embodiment of the disclosure, are understood to mean that the condition or characteristic is defined to be within tolerances that are acceptable for operation of the embodiment for an application for which it is intended.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures and drawings described herein can be spatially arranged in any orientation or manner.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

Section II below describes example embodiments for enhancing live video content streams and managing rewards Section III below describes example mobile device and computing device embodiments that may be used to implement features of the embodiments described herein. Section IV below describes additional examples and advantages, and Section V provides some concluding remarks.

### II. Example Embodiments for Enhancing Live Video Content Streams and Managing Rewards

Methods, systems, apparatuses, devices, and computer program products are provided for enhancing live video content streams and managing reward notifications, determinations, and grants. Such embodiments enable efficient reward determinations and notifications, and grant. For example, a title rewards service may execute on a title reward service host (e.g., a processing system or server) that resides on a network between a streamer client device and client devices of spectators. The title rewards service is configured to determine rewards and provide notifications thereof. The title rewards service positioned between the streamer and spectator client devices is enabled to receive notifications of rewards for spectators from the streamer client device, and to issue a notification of rewards to all the client devices of authenticated spectators determined to be rewarded. In this way, the title rewards service is enabled to manage rewards for any number of spectators for any number of titles by one or more different developers in a manner that is specific to each individual title that is streamed. Rewards are dynamically determined and distributed according to title configurations for each spectator, taking into account factors such as the viewing time, viewed stream events, and/or spectator participation, including, but not limited to, interaction with the title being streamed, etc.

For instance, a user that is playing a title on a client device (e.g., a streamer client device) may stream their title session such that this content stream may be viewed over a network by one or more spectator users at respective client devices (e.g., spectator client devices). Spectators may be enabled to simply view the content stream, while in other cases, spectators may be enabled to view and interact with the title session being streamed. That is, spectators may influence and affect the title session of the user playing the title at the streamer client device, during the title session content stream, by providing messages or votes, by providing in-game items, attributes, selections, power-ups, etc. to the playing user's in-game character during the title session, by causing actions to be taken for the title session being played (e.g., causing an enemy or character in the title session to be effected in some way), and/or the like. Different types and grades of rewards may be earned for viewing and/or spectating, as described herein. Further, spectator participation/interaction may be facilitated by the title rewards service, by the title, by the streamer client device, by spectator client devices, and/or by out-of-band services associated with the title.

Additionally, rewards are earned and distributed to client devices of spectators without a title developer or a title service of the title developer needing to be aware of the spectators or their identities, and without developer-specific title services being created and/or used.

Rewards, such as badges, skins, in-game items, experience points, in-game unlocks, and/or the like, may be granted by a title executed by a streamer client device. In embodiments, one or more rewards may be earned multiple times by spectators, e.g., a reward for every N number of minutes a spectator views a content stream of a title, etc. However, it is also contemplated that rewards issued multiple times may be limited by a maximum limit. Rewards may also be specified as requiring a minimum period of time to have elapsed between reward issuances. Rewards for titles that include both interactive rewards and spectating-only rewards may be decoupled such that each type of reward may be issued independently of the other.

In the embodiments, a reward communication notice is issued by title/game client (e.g., running or executing on a streamer client device) when an event that is tied to a reward takes place. Such events may be tracked on behalf of the title with no requirement for persistent resources (e.g., services and/or storage) by the title developer. Reward communication notices may be transmitted (e.g., via a call operation) to a title reward service host, in a single communication for a particular reward, which then processes the event and performs determination (e.g., via a select operation) against a current list of spectators viewing the content stream that the service is tracking. Accordingly, a determination is made of which spectators should receive a reward, i.e., be issued a reward by the title. Issued rewards may be persistently stored with or by the title reward service host, and can be queried by the title/game client to check for rewards to redeem when a spectator executes the title at their client device or engages a rewards user interface at their client device. Notably, the title is not required to be aware of the number of spectators viewing a content stream, or that there are any viewers at all as the title reward service host is configured to handle the scale-out. Thus, spectators viewing a content stream do not have to authenticate with the title (e.g., at a server of the title developer) in order to receive rewards.

Because reward communication notices are transmitted to a title reward service host, in a single communication from the stream client for a reward, such events occur with significantly less frequency than spectator notices in current solutions. Therefore, the volume of data transmitted over the network is significantly reduced relative to current solutions, as are power and resource utilization of the communication initiator and receiver. Additionally, the title reward service host does not require that titles have their own specific services to handle and process these events and data, which reduces the cost and data storage requirements of the title developers.

Integration of titles with the described title reward service host is virtually seamless, and the title reward services operate as minimally opinionated services for how the titles/game clients decide to reward spectators viewing content streams. The title reward service hosts are scalable to handle very large numbers of spectators for different content streams, and users' data privacy and anonymity are maintained while still being rewarded for watching title/game-client streams. Furthermore, rewards do not require an interactive connection or configuration.

In other words, the embodiments disclosed herein provide enhanced live video content streams and rewards management. These and further embodiments are described in greater detail as follows.

A. Example Embodiments for Content Streaming and Associated Rewards

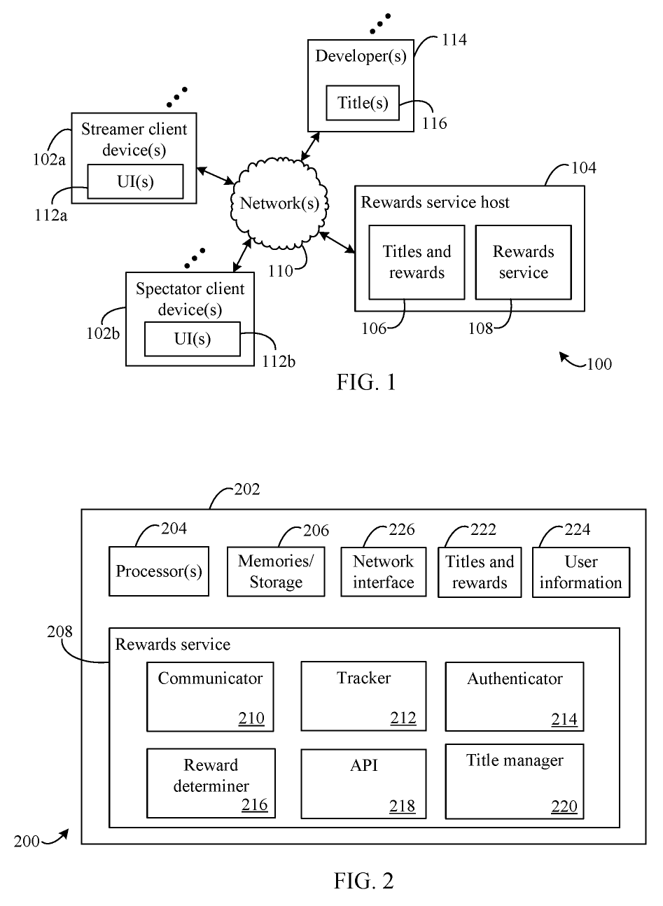

In embodiments, systems and devices may be configured in various ways for live video content streaming and managing associated rewards. For instance, FIG. 1 is a block diagram of a rewards system 100, according to embodiments. Rewards system 100 is configured to enable live video content streams and managing of reward notifications, determinations, and grants, according to embodiments. As shown in FIG. 1, rewards system 100 includes a streamer client device 102a, a spectator client device 102b, a rewards service host 104, and a title developer server 114 which may communicate with each other over a network 110. It should be noted that any numbers of streamer client devices, spectator client devices, and developer servers may be present in various embodiments. Additionally, any combination of the components illustrated in FIG. 1 may be present in rewards system 100, according to embodiments.

As noted above, streamer client device 102a, spectator client device 102b, and rewards service host 104, as well as title developer server 114, are communicatively coupled via network 110. Network 110 may comprise any type of communication links that connect computing devices and servers such as, but not limited to, the Internet, wired or wireless networks and portions thereof, point-to-point connections, local area networks, enterprise networks, and/or the like.

Title developer server 114 may comprise one or more server computers or computing devices, which may include one or more distributed or “cloud-based” servers. Title developer server may be configured to enable developers to develop and/or publish titles, such as video games, interactive applications, etc. Accordingly, title developer server 114, or storage associated therewith, may include one or more titles 116. Title(s) 116 may include code or applications for executing and/or supporting execution of titles developed by a developer. Title(s) 116 may be provided for download to a client device, electronically, over a network as described herein, and/or may be encoded on computer readable storage media to be read/accessed by a client device, to execute a title.

Rewards service host 104 may comprise one or more server computers or computing devices, which may include one or more distributed or “cloud-based” servers. Rewards service host 104 is configured to receive requests from client devices, such as via a user interface (UI) 112a of streamer client device 102a and/or via a UI 112b of spectator client device 102b via network 110 to authenticate a user thereof for a rewards service hosted by rewards service host 104, as described further herein. For example, a user that is playing a title and streaming live content of the title via streamer client device 102a, or a user that is a spectator viewing the streaming live content at spectator client device 102b, may log in and be authenticated to the rewards service hosted by rewards service host 104. Rewards service host 104 is also configured to track authenticated spectating users/client devices logged into the service (e.g., spectator client device 102b), and to track time spent spectating content streams of titles by spectators using spectator client devices 102b. When a notice of a reward (for issue) from the title being streamed from streamer client device 102a is received, rewards service host 104 is configured to notify spectators at spectator client devices 102b of the reward based on reward criteria being met by those spectators. A spectator may then log into the reward service of rewards service host 104, e.g., as a spectator of the title, to redeem the granted reward without the spectator's identity or information being exposed to the title developer or the title developer service of the title.

As illustrated, rewards service host 104 includes titles and rewards data 106 which may be a database of information or other data storage structure, and a rewards service 108. It is noted that titles and rewards data 106 may be located remotely from rewards service host 104 in embodiments, such as in a remote database (not shown for brevity and illustrative clarity) communicatively connected via network 110. It is also contemplated herein that while only a single instance of titles and rewards data 106 is shown in FIG. 1 for brevity and illustrative clarity, multiple instances of titles and rewards data 106 may be present in embodiments, and/or multiple remote databases may also be included.

Titles and rewards data 106, and/or a remote database as described above, may be configured to store data for each title such as, but not limited to, a title name, a title identifier, an integration indicator, a rewards indicator, a rewards list, and/or the like, as described herein. Rewards service 108 may be implemented in hardware or hardware combined with one or both of software and/or firmware, and may be configured to perform any functions/operations described herein for enhancing live video content streams and managing reward notifications, determinations, and grants.

Streamer client device 102a and/or spectator client device 102b may be any type of computing device or computing system, including a game console (e.g., any type of Xbox™ or Xbox One™ console from Microsoft Corporation of Redmond, Wash., any type of PlayStation® console of Sony Corporation, etc.), a terminal, a personal computer, a laptop computer, a tablet device, a smart phone, etc., that may be used by users to play, stream, and/or spectate titles from title developers. Titles may be distributed by developers electronically or via computer readable storage media that may be inserted or uploaded into the described client devices for execution of the titles. As described herein, streaming and spectating may utilize rewards service host 104. Streamer client device 102a and/or spectator client device 102b are configured to provide user authentication/credential information over network 110 to rewards service host 104 to enable users to earn and redeem rewards from titles, as described in further details below. In embodiments, a user may utilize UI 112a or UI 112b for the rewards service of rewards service host 104. In embodiments, streamer client device 102a and/or spectator client device 102b may include a stored instance of such a UI, received from rewards service host 104 or as a component of streamer client device 102a and/or spectator client device 102b. In embodiments, UI 112a and/or UI 112b may be any type of service/application UI, browser, client or electronic communication application, messaging application, portal, and/or the like.

It should be noted that streamer client device 102a may be configured to operate as a spectator client device like spectator client device 102b, and that spectator client device 102b may be configured to operate as a streamer client device like streamer client device 102a. That is, the different client devices described herein are not limited in their functionality and operation by their labels which are attributed as such only for purposes of illustration and description herein. Additionally, streamer client device 102a and/or spectator client device 102b may each be configured to play titles without streaming or spectator viewing, as will be understood by persons of skill in the art(s) having the benefit of this disclosure.

Note that as described herein, embodiments are applicable to any type of system where a rewards service host communicates with client devices over a network. One example is where the rewards services host is a “cloud” application or service in a network architecture/platform. A cloud platform includes a networked set of computing resources, including servers, routers, etc., that are configurable, shareable, provide data security, and are accessible over a network such as the Internet. Cloud applications run on the resources, often atop operating systems that run on the resources, for entities that access the applications over the network. A cloud platform may support multi-tenancy, where cloud platform-based software services multiple tenants, with each tenant including one or more users who share common access to software services of the cloud platform. Furthermore, a cloud platform may support hypervisors implemented as hardware, software, and/or firmware that run virtual machines (emulated computer systems, including operating systems) for tenants. A hypervisor presents a virtual operating platform for tenants.

Accordingly, a rewards service host system, such as rewards service host 104, may be configured in various ways for improvements and enhancements in live video content streams and managing rewards for users of streamer client devices and/or spectator client devices. For example, FIG. 2 is a block diagram of a rewards service host system 200 (“system 200” herein) configured for improvements and enhancements in live video content streams and managing rewards. System 200 is an embodiment of rewards service host 104 of FIG. 1. System 200 is described as follows.

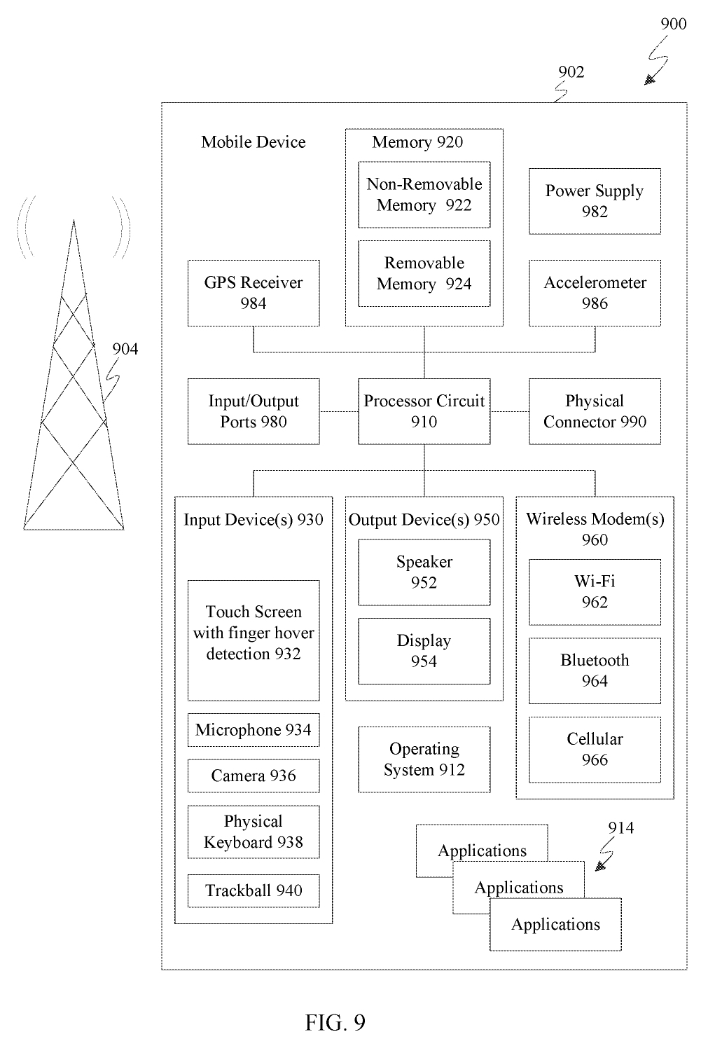

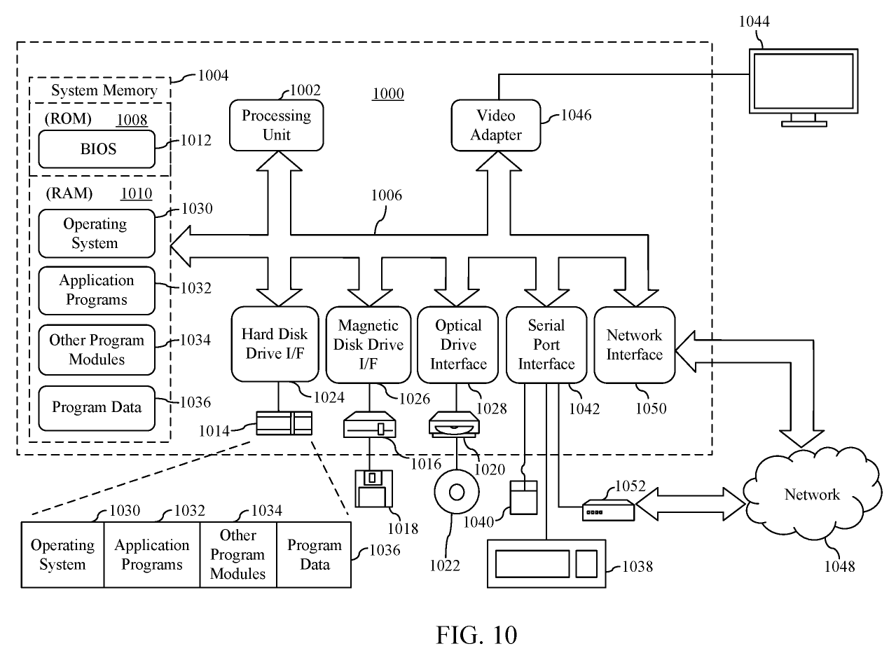

System 200 includes a rewards service host 202, which may be an embodiment of rewards service host 102 of FIG. 1, and may be any type of server computer or computing device, as mentioned elsewhere herein, or as otherwise known, including cloud-based server implementations. As shown in FIG. 2, system 200 and rewards service host 202 includes one or more of a processor (“processor”) 204, one or more of a memory and/or other physical storage device (“memory”) 206, one or more network interfaces (“network interface”) 226, and a rewards service 208 that may be an embodiment of rewards service 108 of FIG. 1. System 200 may also include titles and rewards information 222, which may be an embodiment of titles and rewards information 106 of FIG. 1, as well as user information 224. System 200 may also include additional components (not shown for brevity and illustrative clarity) including, but not limited to, components and subcomponents of other systems herein, such as UI 112a or UI 112b, title 116, etc., as well as those described below with respect to FIGS. 9 and 10, such as an operating system.

Processor 204 and memory 206 may respectively be any type of processor circuit or memory that is described herein, and/or as would be understood by a person of skill in the relevant art(s) having the benefit of this disclosure. Processor 204 and memory 206 may each respectively comprise one or more processors or memories, different types of processors or memories, remote processors or memories, and/or distributed processors or memories. Processor 204 comprises circuitry that is configured to execute computer program instructions such as but not limited to embodiments of rewards service 208, which may be implemented as computer program instructions for enhancement of live content streams and rewards management, etc., as described herein. Memory 206 is configured to store such computer program instructions/code, as well as to store other information and data described in this disclosure including, without limitation, a title and rewards information, user information, tracking information, etc.

Network interface 226 may be any type of wired and/or wireless network adapter, modem, etc., configured to enable system 200 to communicate with other devices over a network, such as communications between system 200 and other devices utilized in a network as described herein for live content streaming and rewards (e.g., streamer client device 102a, spectator client device 102b, and/or title developer server 114) over a network such as network 110 as described above with respect to FIG. 1.

Titles and rewards information 222 may include entries for one or more titles. Each entry may include, without limitation, a title name, a title identifier, an integration indicator, a rewards indicator, a rewards list, and/or the like, as would be apparent to those of skill in the relevant art(s) having the benefit of this disclosure. A rewards list may include, but not be limited to, rewards information for a title such as types of rewards issued, a frequency of rewards issued, a number of spectators that view content streams multiple times, a number of streamers, temporal data, e.g., times, dates, etc., that rewards are issued, and/or the like.

User information 224 may include, without limitation, information regarding a user, a user's account (e.g., login credentials, a user alias or handle, etc.), a user's client device, a user's network, titles played or viewed as a spectator by the user, user rewards earned, and indications of users being logged into system 200. User information 224 may also include criteria data such as information regarding tracked time viewing content streams, spectator participation, title events viewed during a content stream, and/or any other types of criteria data for qualifying to receive rewards.

Rewards service 208 includes a plurality of components for performing the techniques described herein for enhancements in live video content streams and managing rewards. As shown, rewards service 208 includes communicator 210, a tracker 212, an authenticator 214, a reward determiner 216, application programming interfaces (API) 218, and a title manager 220. While shown separately for illustrative clarity, in embodiments, one or more of communicator 210, tracker 212, authenticator 214, reward determiner 216, API 218, and/or title manager 220 may be combined together and/or as a part of other components of system 200. In some embodiments, less than all of the components of rewards service 208 illustrated in FIG. 2 may be included. In software implementations, one or more components of rewards service 208 and/or rewards service host 202 may be stored in memory 206 and may be executed by processor 204.

Communicator 210 is configured to receive and/or transmit electronic communications for rewards service 208 of system 200. For instance, communicator 210 is configured to receive indications from client devices regarding rewards, authentication requests, commands, notices of streams or spectators viewing, etc., as described below, such as via network interface 226. Similarly, rewards service 208 of system 200 is configured to issue, transmit, and/or provide, reward notices for spectators, notifications of stored rewards, etc., as described below via communicator 210.

Tracker 212 may include a spectator tracker, a time tracker, and/or other tracking components to perform the techniques described herein. A spectator tracker of tracker 212 may be configured to track spectators logged in to, or authenticated and online, with respect to rewards service 208 and system 200. A time tracker of tracker 212 may be configured to track times spent view content streams by spectators. Tracker 212 is also configured to track other events, as described, for which spectators may earn rewards.

Authenticator 214 is configured to authenticate users playing titles (including streaming of titles) and/or users spectating (i.e., viewing) content streams for rewards service 208 of system 200 via their respective client devices (i.e., streamer client device 102a and spectator client device 102b). Authentication may be based on automatic or manual provision of user credentials for rewards service 208 of system 200.

API 218 may include one or more APIs to perform specific functions related to tracking and communications described herein. In embodiments, one or more APIs of API 218 may be included in, or utilized by, reward determiner 216 and/or communicator 210. For example, a rewards issuer API may be included in, or utilized by, reward determiner 216 and/or communicator 210 to provide notices of rewards, for which spectators have met rewards criteria, to the spectators as a single API call, i.e., a single message communication. In embodiments, a rewards issuer API may be configured to concurrently issue reward notifications for up to 100,000 spectators, or more.

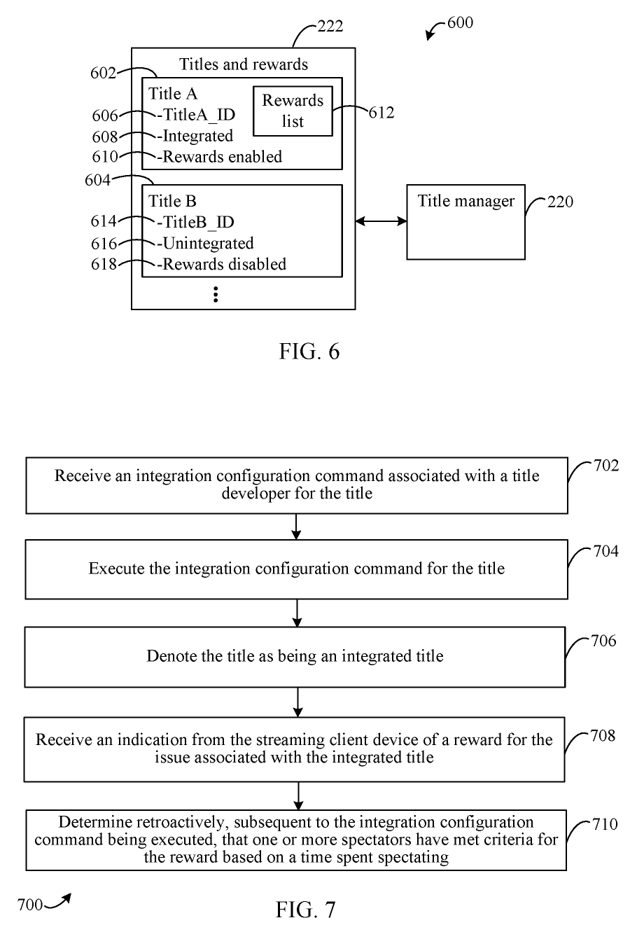

Title manager 220 of rewards service 208 in FIG. 2 is configured to associate a title identifiers with titles that are executed by streamer client device 102a and/or that are viewed by spectators during content streams for integrated and unintegrated titles. Title manager 220 is also configured to manage integration of titles, as well as titles and rewards information, as described in further detail below with respect to FIGS. 5-6.

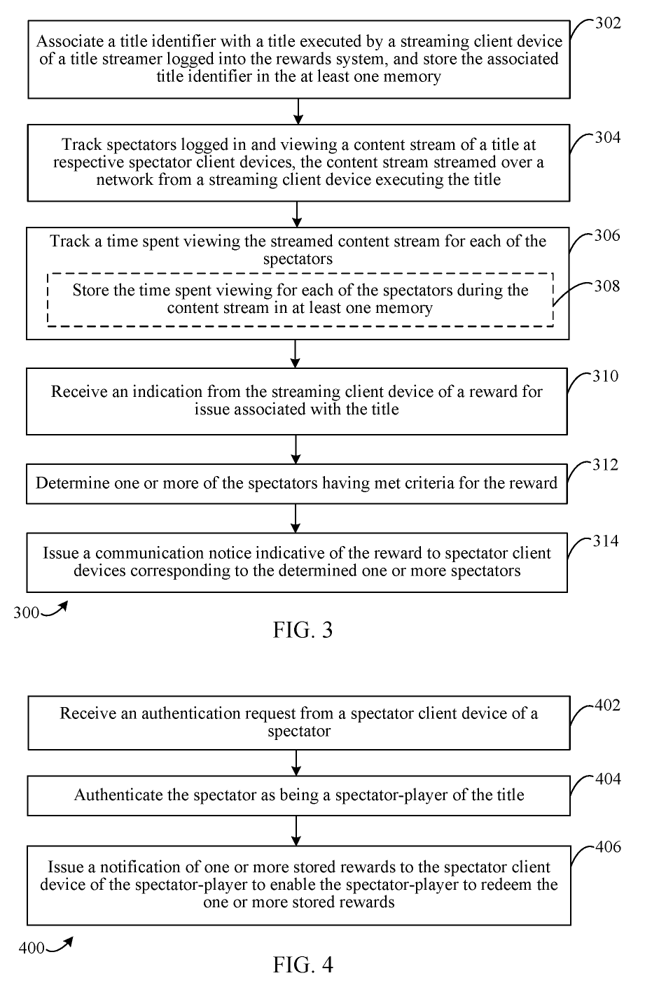

Rewards service 208 may operate in various ways to enable enhancements in live video content streams and managing rewards. For instance, FIG. 3 shows a flowchart 300 for enhancements in live video content streams and managing rewards, according to an example embodiment. Rewards service 208 may operate according to flowchart 300, in an embodiment. Further structural and operational examples will be apparent to persons skilled in the relevant art(s) based on the following description. Flowchart 300 is described as follows with respect to system 100 of FIG. 1 and system 200 of FIG. 2.

Flowchart 300 begins at step 302. In step 302, a title identifier is associated with a title executed by a streamer client device of a title streamer logged into the rewards system, and store the associated title identifier in the at least one memory. For instance, title manager 220 of rewards service 208 in FIG. 2 is configured to associate a title identifier with a title that is executed by streamer client device 102a. In embodiments, a title streamer may be logged into rewards service 208 of system 200, e.g., a user playing a title and streaming their play via streamer client device 102a. In some embodiments, the title is an unintegrated title, with respect to rewards service 208—that is, a title may associated with a title identifier by title manager 220 without the granting of rewards being configured.

In step 304, spectators logged in and viewing a content stream of a title at respective spectator client devices are tracked, where the content stream is streamed over a network from a streamer client device executing the title. For example, tracker 212 of FIG. 2 may include a spectator tracker (not shown for illustrative clarity). The spectator tracker of tracker 212 is configured to track any number of spectators logged in and spectators logged in and viewing a content stream of a title at respective spectator client devices, such as in a spectator list, database, and/or other data structure. That is, a user playing a title and/or a user spectating (i.e., viewing) a content stream may be authenticated, e.g., by a spectator authenticator of authenticator 214, and logged in to rewards service 208 of system 200 via their respective client devices (i.e., streamer client device 102a and spectator client device 102b). Spectators may be authenticated by the spectator authenticator of authenticator 214 through user identification credentials, provided via spectator client device 102b, that are validated against stored user information 224. A spectator that is logged in and tracked (e.g., by login name or other user identifier) may be issued reward notifications as described below.

In step 306, a time spent viewing the streamed content stream is tracked for each of the spectators. For instance, tracker 212 of FIG. 2 may include a time tracker (not shown for illustrative clarity). The time tracker of tracker 212 is configured to track a time spent viewing the streamed content stream for each of the spectators of a content stream tracked in step 304. As an example, when a spectator selects a title on which to spectate or view a live content stream via their spectator client device 102b, the amount of time spent viewing the content stream is tracked by tracker 212. In an embodiment, title manager 220 and/or tracker 212 of FIG. 2 may be configured to monitor which titles are streamed from a streamer client device 102a and the identities of spectators viewing the streams.

In step 308, the time spent viewing for each of the spectators during the content stream is stored in at least one memory. For example, the time tracked in step 306 above may be stored in a storage such as memory 206 by the time tracker of tracker 212. The time spent viewing by a given spectator may be stored with user information 224, in embodiments.

In step 310, an indication is received from the streamer client device of a reward for issue associated with the title. For instance, a streamer client device such as streamer client device 102a is configured to provide indications that rewards for titles are available for issue to spectators viewing live content streams. Such indications may be generated by the streamer client device for a title in any manner, such as when the player of the title achieves a particular score, reaches a predetermined milestone for the title (e.g., reaches a predetermined amount of game progress, finds a particular in-game item, discovers a particular in-game location, reaches a predetermined character and/or game level, etc.), gains a predetermined number of spectators, on a periodic basis, based on amounts of time that the content stream has been active, and/or based on any other criteria designated by the game developer. System 200 is configured to receive these indications via network interface 226 and communicator 210 at reward determiner 216. Reward determiner 216 is configured to determine from the indication a title name or title identifier, the type and/or content of the reward for issue, reward criteria to qualify for the reward, and/or the like. Reward determiner 216 may be configured to store indications received for rewards in a storage such as memory 206, and indications may be stored with titles and rewards information 222.

Indications may be provided by streamer client device and received by system 200 when spectators are viewing live content streams, but also when no spectators are viewing. When no spectators are viewing, reward determiner 216 may be configured to store indications as noted above.

In step 312, one or more of the spectators are determined as having met criteria for the reward. For example, rewards determiner 216 is configured to determine if any spectators have met criteria for the reward that is indicated in step 310. Reward determiner 216 is configured to determine whether spectators have met criteria such as by comparing tracked time spent viewing (e.g., via the time tracker of tracker 212 described above) for spectators logged in and viewing a content stream (e.g., via the spectator tracker of tracker 212 described above) against reward criteria (e.g., as provided in the indication from streamer client device 102a). Criteria for rewards may be dependent on the type or content of the reward for issue, and may include, without limitation, one or more of a time or a total amount of time spent by a spectator viewing the content stream, a total amount of time spent by a spectator viewing the content stream and at least one previous content stream, a number of rewards a spectator has previously been granted for the title, a number of times a spectator has viewed content streams of the title, interactive participation in the content stream by a spectator while viewing the content stream, occurrence of a pre-determined event while a spectator views the content stream, and/or the like as will be understood by persons of skill in the relevant art(s) having the benefit of this disclosure. In some embodiments, rewards may be issued to any spectators who were viewing a content stream, or who were viewing the content stream within a prior time period (e.g., within the last hour).

As non-limiting, illustrative examples, a reward may be indicated for issue to any spectators having viewed the live stream for a total number of minutes (e.g., 5 minutes, 10 minutes, etc.) indicated for the reward, or for any spectators having viewed live streams for a title at least 3, 5, 10, etc. times. Additionally, if a spectator has been issued a set number of minor rewards (e.g., 3, 5, 10, etc., minor rewards), the spectator may meet criteria for a major reward on the next reward issuance. Rewards may be issued to specific spectators for their participation during the viewing of live streams, e.g., granting a user playing a title certain bonuses or modifiers during the streaming. Spectators viewing major events, e.g., milestones reached by the user playing the title, campaign completions, defeating a boss of a level of the title, and/or the like, during a content stream may also be qualified for issued rewards.

Accordingly, and as previously noted, the title rewards service is centrally positioned between the streamer and spectator client devices, and is enabled to receive notifications of rewards for spectators from the streamer client device, and to determine spectators to be rewarded by the title executed and being streamed from stream client device. In this way, the title rewards service is enabled to manage rewards and improve the content streaming system, and the user experience thereof, for any number of spectators for any number of titles by one or more different developers. This is accomplished by dynamically determining rewards at a central location according to the specific title configurations of any different title for each spectator of titles being streamed, taking into account factors such as the viewing time, viewed stream events, and/or spectator participation. Thus, customization for rewards issued to spectators is enabled, per-title, from a central service.

Additionally, in embodiments, the title rewards service does not track the state of the title being streamed to determine reward scenarios, as is performed in current title services solutions, but rather is configured to receive indications from streamer client devices of rewards for issue associated with the titles that are streamed. In this way, the described embodiments for title rewards services decrease memory and processor usage for their host systems.

In step 314, a communication notice is issued that is indicative of the reward to spectator client devices corresponding to the determined one or more spectators. For instance, an API of API 218 and/or communicator 210 may be configured, as a rewards issuer, to issue a communication notice indicative of the reward, as indicated in step 310, to spectator client devices corresponding to the determined spectators of step 312 having met the reward criteria as determined by reward determiner 216. In embodiments, API 218 is configured to provide a single communication notice (e.g., as a multi-cast message or the like) that is received by all spectators meeting the reward criteria. The communication notice includes information indicative of the reward issuance for each of the determined spectators of step 312. During the viewing of the content stream by a given spectator, spectator client device 102b may cause a corresponding notification (e.g., a message, an alert, an icon, etc.) to be displayed to the spectator.

For instance, an API of API 218 may also be configured to issue, in real-time, the communication notice in step 314 to the spectator client devices corresponding to the determined spectators. Thus, spectators are notified of rewards earned as they view live content streams. As similarly described above with respect to steps 310 and 312, the centrally located title rewards service is configured to improve title reward service host system performance with respect to rewards management and determination, as well as hardware utilization. Additionally, network traffic and load is significantly reduced by the described embodiments as the described title rewards service is configured to issue a single notification for rewards earned to all the client devices of authenticated spectators. That is, rewards notices are distributed in a manner, e.g., via API 218 as noted above, that does not require individual notices to spectators from a title or a title service. The network traffic reduced according to the described title reward services and systems is significant as the number of spectators supported for the streaming of a title can be in the thousands to the hundreds of thousands.

After being notified of rewards to be issued for which a spectator has met criteria, the spectator may log in or authenticate to rewards manager 208 of system 200 via spectator client device 102b, or select a change in operation/mode of spectator client device 102b, to interact with spectator client device 102b as a spectator-player. That is, a spectator may then act as a user that also plays a title to redeem issued rewards.

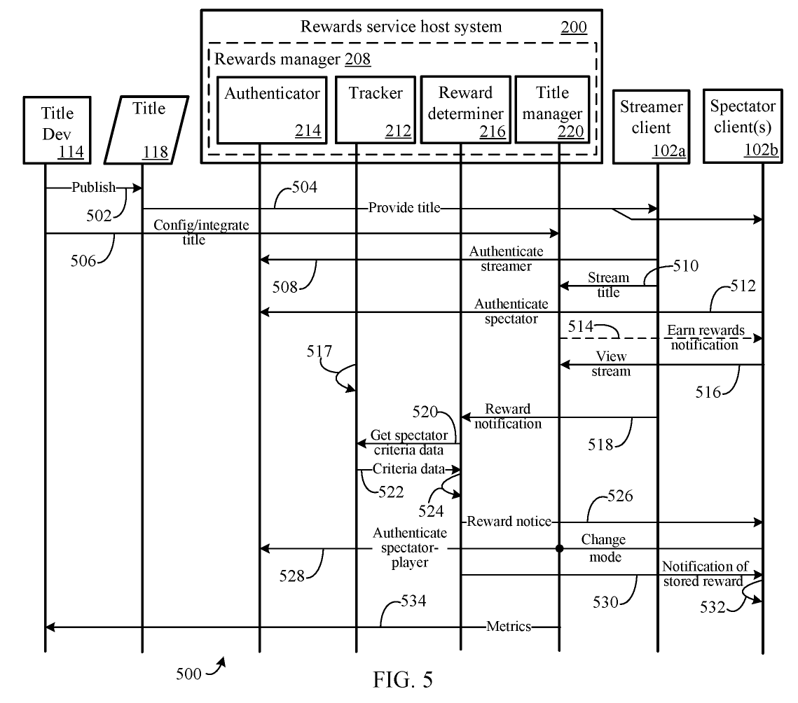

For instance, FIG. 4 shows a flowchart 400 for enhancements in live video content streams and managing rewards, according to an example embodiment. Rewards service 208 may operate according to flowchart 400. Flowchart 400 may be a further embodiment of flowchart 300 of FIG. 3. Further structural and operational examples will be apparent to persons skilled in the relevant art(s) based on the following description. Flowchart 400 is described as follows with respect to system 100 of FIG. 1 and system 200 of FIG. 2.

Flowchart 400 begins at step 402. In step 402, an authentication request is received from a spectator client device of a spectator. For example, the spectator authenticator of authenticator 214 may receive the authentication request via communicator 210 and/or network interface 226 from spectator client device 102b for authentication of a spectator as a player or spectator-player. In embodiments, the authentication request may include a specific title or title identifier for which the spectator wants to play or redeem/claim rewards.

In step 404, the spectator is authenticated as being a spectator-player of the title. For instance, as noted above, the spectator authenticator of authenticator 214 is configured to authenticate spectators through user identification credentials, provided via spectator client device 102b, that are validated against user information 224.

In some embodiments, the authentication of a spectator to rewards manager 208 of system 200 for viewing a live content stream, e.g., as noted above in the description of step 304 in flowchart 300 of FIG. 3, may be sufficient authentication for a spectator as a spectator-player. In such a case, the spectator may change the operation/mode of spectator client device 102b to interact with spectator client device 102b as a spectator-player and play a title, or redeem rewards for the title, on the client device without the actual authenticating described in step 402 and step 404, but instead where step 402 and step 404 serve to give notice to rewards manager 208 of system 200 that the spectator now desires to interact with spectator client device 102b as a spectator-player.

In step 406, a notification of one or more stored rewards is issued to the spectator client device of the spectator-player to enable the spectator-player to redeem the one or more stored rewards. For example, the rewards issuer (e.g., an API of API 218 and/or communicator 210) is configured to provide a notification of rewards for the spectator that are stored by system 200 (e.g., as determined in step 312 by rewards determiner 216) to spectator client device 102b. This notification serves to inform spectator client device 102b that the spectator-player has met the reward criteria for a reward and that the reward may be redeemed at spectator client device 102b.

In embodiments, the spectator-player at spectator client device 102b may redeem rewards “in-game,” i.e., while executing the title at spectator client device 102b, and/or via a menu or rewards UI at spectator client device 102b.

Accordingly, flowchart 300 and flowchart 400 (and rewards manager 208 of system 200) enable improvements and enhancements in live video content streams and managing rewards by having a centralized rewards manager 208 configured to operate as a rewards manager for any number of titles of different developers for any number of spectators; allowing efficient, network traffic/load reducing notifications and issuance of rewards that are dynamically determined and generated according to criteria on a per-reward basis for a given content stream across all spectators as determined by the titles; and maintaining integrity and security of user identity information by not requiring authentication with other services for viewing live content streams.

FIG. 5 and FIG. 6 are now described. In FIG. 5, a flow diagram 500 for enhancements in live video content streams and managing rewards, according to an example embodiment. Rewards service 208 may operate according to flow diagram 500. Flow diagram 500 may be a further embodiment of flowchart 300 of FIG. 3 and/or flowchart 400 of FIG. 4. Further structural and operational examples will be apparent to persons skilled in the relevant art(s) based on the following description.

FIG. 6 shows a block diagram of a title management subsystem 600 for managing title and rewards information. Title management subsystem 600 includes title manager 220, as described above with respect to rewards manager 208 and titles and rewards information 222 of FIG. 2. As illustrated, titles and rewards information 222 includes information for titles, e.g., a Title A 602 and a Title B 604. While two titles are shown for description and illustrative brevity, additional or fewer titles may be included. In embodiments, titles and rewards information 222 may be stored in a storage such as memory 206 of system 200 in FIG. 2.

Flow diagram 500 of FIG. 5 is described as follows with respect to system 100 of FIG. 1 and system 200 of FIG. 2.

Flow diagram 500 begins with step 502. In step 502, a title developer such as title developer 114 publishes a title such as title 116, as illustrated in FIG. 1. As noted above, titles may be published electronically for download over a network, and/or may be published as executable titles on computer-readable storage media, such as digital versatile discs (DVDs) or other articles of manufacture. In step 504, title 116 may be provided to client devices, such as streamer client device 102a and/or spectator client device 102b as a downloaded program, as computer-readable storage media, and/or the like. In embodiments, title 116 may be provided from, and obtained by, third-party distributors without direct interaction with title developer 114 by users. Thus, titles may then installed and/or executed by the client devices to perform functions and operations as described herein.

Title developer 114 may configure or integrate title 116 with rewards manager 208 of system 200 via title manager 220 in step 506. Integration of title 116 may include configuring rewards to be issued for spectators viewing live content streams of title 116. However, it should be noted that integration, per step 506, is not required for rewards manager 208 to track spectator viewing and actions, nor is integration required to stream content from title 116.

In step 508, a user that desires to play title 116 on streamer client device 102a requests authentication (or registration and/or authentication) with rewards manager 208 via authenticator 214, e.g., by providing user information/credentials. The user may then stream title 116 from streamer client device 102a, and rewards manager 208 is configured to track spectators of the content stream by providing an indication to title manager 220 in step 510. In step 512, another user, e.g., a spectator, that desires to view the content stream of title 116 from step 510 on spectator client device 102b requests authentication with rewards manager 208 via authenticator 214, e.g., by providing user information/credentials. The authentication request of the spectator may include an indication or identifier of title 116 that the spectator desires to view, while in other embodiments, subsequent to authentication in step 512, the spectator may select title 116 to view via spectator client device 102b, as shown by step 516. The indication of title 116 for viewing by the spectator may cause rewards manager 208 to execute title manager 220 to provide in step 514 an earn rewards notification to spectator client device 102b for the spectator that the title being streamed has rewards that may be earned/issued for spectators. It should be noted that when the authentication request of the spectator in step 512 includes an indication of title 116 for desired viewing, step 514 may precede step 516, while in embodiments for which step 516 provides the indication that title 116 is desired for viewing, step 516 may precede step 514. Player and spectator users may be authenticated by the spectator authenticator of authenticator 214 through user identification credentials, provided via spectator client device 102b, that are validated against stored user information 224 in steps 508 and 512. Additionally, user information may be updated and stored during steps 508 and 512.

In step 517, data/information for viewing activity of a spectator view a content stream via spectator client device 102b is tracked and stored by tracker 212. The tracked data/information may be stored in storage (e.g., memory 206 of FIG. 2), and may include any data/information related to rewards criteria as described herein and/or any actions, behaviors, participation, etc., of spectators.

It is also contemplated herein that the earn rewards notification in step 514 may be provided by title manager 220 before, at the start of, or subsequently during the viewing of the content stream for title 116.

Turning now to FIG. 6 and title management subsystem 600, further details of tile manager 220, and titles and rewards information 222 are provided. As noted above, titles and rewards information 222 is illustrated as including an entry for Title A 602 and Title B 604. The entry for Title A 602 may include title information including, but without limitation, the title name (“Title A”), a title identifier 606 (“TitleA_ID”), an integration indicator 608 (shown as “integrated”), and a rewards indicator 610 (shown as “enabled). Title A 602 may also include rewards information such as a rewards list 612. Rewards list 612 may include, without limitation, rewards information for Title A, such as but not limited to, types of rewards issued, a frequency of rewards issued, a number of spectators that view content streams multiple times, a number of streamers, temporal data, e.g., times, dates, etc., that rewards are issued, and/or the like.

The entry for Title B 604 may include title information including, but without limitation, the title name (“Title B”), a title identifier 614 (“TitleB_ID”). The entry for Title B also includes an integration indicator 616 (shown as “unintegrated”). Because Title B is not integrated with rewards service 208, a rewards indicator 618 is shown as “disabled” because rewards are not configured for a title that is unintegrated, according to embodiments. Additionally, Title B 604 is not shown to include rewards information such as a rewards list (until such time that Title B is integrated).

Accordingly, title manager 220 is enabled/configured, through title and rewards information 222, to allow and note integration of titles, configure/allow rewards for their issuance, identify titles being streamed and/or viewed even when such titles are unintegrated, and provide notifications that rewards may be issued for spectators of titles as in step 514. Furthermore, rewards information from rewards list 612 may be provided to title developers in the form of title metrics, as described in further detail below, without associating the title metrics with specific user identities.

Referring again to flow diagram 500 of FIG. 5, during the user's playing and streaming of content of title 116 via streamer client device 102a, title 116 may determine that spectator rewards may be issued for spectators meeting rewards criteria. For instance, streamer client device 102a may provide a reward notification to rewards manager 208 and reward determiner 216 when rewards are provided for issue in step 518 from title 116 executing on streamer client device 102b. Reward determiner 216 is then configured to get spectator criteria data in step 520 from tracker 212 (which may store such data in memory 206) or directly from in memory 206 (not shown for illustrative clarity). Spectator criteria data may be included in user information 224, as described above. In step 522, the criteria data is provided to reward determiner 216 for a determination in step 524 of whether any spectators meet the reward criteria for the reward in the notification of step 518 (e.g., as described above in step 310 and step 312 of flowchart 300). In embodiments, reward determiner 216 is configured to make determinations for meeting criteria by spectators in real-time, or in near real time. In step 524, rewards for which spectators meet reward criteria may also be stored with user information 224.

In step 526, a reward notice is provided to spectator client devices 102b of spectators that meet the reward criteria. As noted above, a rewards issuer is configured to issue a communication notice indicative of the reward to spectator client devices corresponding to the determined one or more spectators. In embodiments, an API of API 218 may be configured as the reward issuer, and the API may be a part of, or operate in conjunction with, rewards determiner 216. The API may be configured to provide a single communication that is broadcast to any or all of the spectators determined to meet the reward criteria. The reward issuer and/or API may be configured to issue the reward notice to spectator client devices 102b of spectators in real-time, or in near real time. This enables a spectator who is eligible to receive the reward to be notified in real-time, or in near real time, that they have earned a spectating reward while they are viewing a content stream.

Thus, the described content stream and rewards manage system and process enables network traffic and load to be greatly reduced for network 110, and power consumption, processing cycles, and memory footprint of system 200 are also reduced enabling a rewards service host system that is more efficient over current solutions. The current state of the art lacks a rewards service host system that is configured/programmed to operate in this efficient manner.

A spectator that earns a reward while viewing a content stream may subsequently redeem their reward via spectator client device 102b. For example, as described above with respect to flowchart 400 of FIG. 4, the spectator authenticator of authenticator 214 may receive an authentication request that may include a specific title or title identifier for which the spectator wants to play or redeem/claim rewards at spectator client device 102b, or the spectator may change the operation/mode of spectator client device 102b to interact with spectator client device 102b as a spectator-player and play a title, or redeem rewards for the title, on the client device without additional authentication, as shown in step 528. A notification of one or more stored rewards is issued to spectator client device 102b of the spectator-player to enable the spectator-player to redeem the one or more stored rewards in step 530. In embodiments, the rewards issuer (e.g., an API of API 218 and/or communicator 210) may provide the notification of issued rewards for the spectator that are stored by system 200 (e.g., as part of user information 224) where the notification informs spectator client device 102b that the spectator-player has met the reward criteria for a reward and that the reward may be redeemed at spectator client device 102b at step 532, e.g., via a UI presented in-game, or otherwise, by spectator client device 102b.

System 200 may also be configured to provide title metrics for title 116 to title developer 114 periodically and/or by request from title developer 114 in step 534. Title metrics may be stored with title and rewards information 222 in a rewards list such as rewards list 612 of FIG. 6, in embodiments. Title developer 114 may be provided title metrics via a metrics API, e.g., of API 218 of system 200, configured to expose metrics for title developers to track the statistics and progress that viewers achieve while viewing streamed title content. It should be noted metrics stored by rewards systems in this manner do not express individual user rewards, according to embodiments, but can be used by the title or title developer to generate rewards based off of in-game logic. The metrics API is configured to allow title developers to store values, e.g., strings or doubles, objects, nested objects, and/or other formats and/or types for data values, keyed off of arbitrary string identifiers, and to manipulate these values using a set of pre-defined operations that can be applied against whole audiences or subsets of users. For instance, in embodiments, values may be set, conditionally set, incremented, and/or decremented, etc., although other value changes and manipulations are also contemplated herein, as would be understood by persons of skill in the relevant art(s) having the benefit of this disclosure.

Title metrics may include without limitation, rewards information for Title A, such as but not limited to, types of rewards issued (e.g., virtual game coins that are spendable or non-spendable, virtual images, videos, items/characters usable in games, achievement points, etc.), a frequency of rewards issued, a number of spectators that view content streams multiple times, a number of streamers, temporal data, e.g., times, dates, etc., that rewards are issued, percentages of spectators that redeem rewards after earning, viewership metrics for channels with rewards versus channels without, authentication rates for channels with rewards versus channels without, and/or the like. Title metrics may be provided to title developer 114 without any identifying information of users—that is, the privacy and personal information of users, e.g., users who play/stream titles and spectator users that view content streams, is protected and not shared with title developers, according to embodiments. Accordingly, the described title rewards service system improves user identity security. It is also contemplated that in some embodiments, personal information of users may be shared with titles and/or title developers via an “opt-in” option, by default, etc.

As noted herein, system 200 and rewards manager 208 are configured to track users playing and streaming unintegrated titles, as well as spectators viewing content streams for unintegrated titles. For instance, system 200 and rewards manager 208 are configured to associated unintegrated titles with title identifiers for such tracking, and also to track spectators view content streams and their times spent viewing (in addition to storing viewing times), as described above in step 302, step 304, step 306, and step 310 of flowchart 300 in FIG. 3. Additionally, step 506 in flow diagram 500 of FIG. 5 described above details that a title developer may request for a title be integrated with system 200 and rewards manager 208 so that rewards for the title are configured to be issued.

Referring now to FIG. 7, a flowchart 700 for enhancements in live video content streams and managing rewards is shown, according to an example embodiment. Rewards service 208 may operate according to flowchart 700 for management of unintegrated titles, in an embodiment. Further structural and operational examples will be apparent to persons skilled in the relevant art(s) based on the following description. Flowchart 700 may be an embodiment of flowchart 300 of FIG. 2, flowchart 400 of FIG. 4, and/or flow diagram 500 of FIG. 5. Flowchart 700 is described as follows with respect to system 100 of FIG. 1 and system 200 of FIG. 2.

Flowchart 700 begins at step 702. In step 702, an integration configuration command associated with a title developer for the title is received. For instance, step 506 in flow diagram 500 of FIG. 5 above describes how title manager 220 of system 200 receives a communication from title developer 114 for integration of title 116 that may include enabling rewards to be issued for spectators. The receipt of the communication may cause an integration configuration command associated with a title developer for the title to be received, e.g., from an administrator of system 200 or automatically from memory 206.

In step 704, the integration configuration command for the title is executed. For example, the integration configuration command may be executed by processor 204 and may be executed in conjunction with title manager 220. For instance, the execution of the integration configuration command may cause title manager 220 to modify the entry for a title in title and rewards information 222, as shown in subsystem 600 of FIG. 6. In some embodiments, an administrator of system 200 may modify title and rewards information 222 responsive to the integration configuration command and cause the command to be executed to finalize integration.

In step 706, the title is denoted as being an integrated title. For instance, title manager 220 to modify the entry for a title in title and rewards information 222 to denote an “integrated” title and that rewards are “enabled,” i.e., configured to be issued. Additionally, a rewards list may be subsequently compiled for the now-integrated title when the title is streamed and/or viewed. It should be noted herein that a title developer is not required to configure rewards themselves, i.e., set up rewards to be issued. That is, a title itself may be configured/developed with rewards to be issued, including criteria to be met by spectators to earn the rewards.

With a previously-unintegrated title having been integrated and having rewards enabled therefor, a title may issue retroactive rewards for spectators that have viewed content streams of the title in the past when unintegrated.

In step 708, an indication is received from the streamer client device of a reward for the issue associated with the integrated title. The indication may be issued and received as similarly described in step 310 of flowchart 300 in FIG. 3. In embodiments, the indication in step 708 may be for a retroactive reward. In such cases, the indication in step 708 may be issued and received when a content stream is provided subsequent to integration of the title, when a spectator is next viewing a content stream for the now-integrated title, or during a time period when the spectator is not actively viewing a content stream but is authenticated to rewards manager 208 of system 200.

In step 710, one or more spectators that have met criteria for the reward based on a time spent spectating are determined retroactively, subsequent to the integration configuration command being executed. For example, based on the indication in step 708, reward determiner 216 may be configured to retroactively determine spectators that meet criteria for the reward indicated. That is, spectators may be tracked for viewing content streams of unintegrated titles, as noted above, and stored viewing information for these spectators may be utilized by reward determiner 216 against reward criteria for rewards issued after title integration for determining these spectators meet the reward criteria.

Subsequent to step 710, a rewards issuer may be configured to issue a communication notice indicative of the reward to spectator client devices corresponding to the determined one or more spectators, as described in step 314 of flowchart 300 in FIG. 3.

B. Example Client Embodiments

Client devices described herein, e.g., streamer client device 102a and/or spectator client device 102b as shown in FIG. 1, are configured to interact with rewards service host 104 of FIG. 1 and/or rewards service 208 of system 200 in FIG. 2. As noted above, streamer client device 102a and/or spectator client device 102b may be any type of computing device or computing system, including a game console, a terminal, a personal computer, a laptop computer, a tablet device, a smart phone, etc., that may be used by users to play, stream, and/or spectate (i.e., view streams of) titles of title developers.

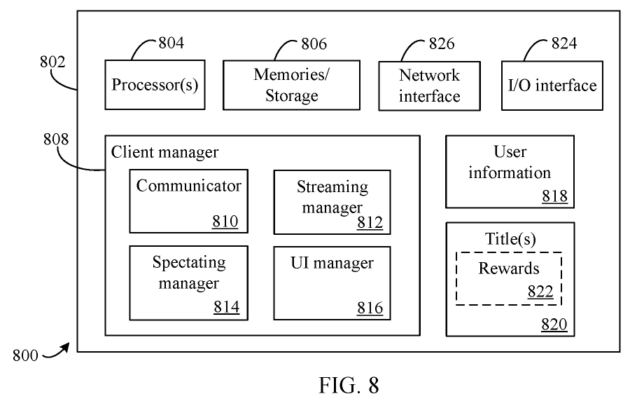

Turning now to FIG. 8, a block diagram of a client system 800 (or “system 800” herein) is shown. System 800 is described as follows.

System 800 includes a client device 802, which may be an embodiment of streamer client device 102a and/or spectator client device 102b of FIG. 1, and may be any type of computer or computing device, game console, etc., as mentioned elsewhere herein, or as otherwise known. As shown in FIG. 8, system 800 and client device 802 include one or more of a processor (“processor”) 804, one or more of a memory and/or other physical storage device (“memory”) 806, one or more network interfaces (“network interface”) 826, an input/output (“I/O”) interface 824, and a client manager 808. System 200 may also include a title 820 having rewards 822. System 800 may also include additional components (not shown for brevity and illustrative clarity) including, but not limited to, components and subcomponents of other systems herein, as well as those described below with respect to FIGS. 9 and 10, such as an operating system.

Processor 804, memory 806, and network interface 826, may be similarly configured as processor 204, memory 206, and network interface 226 of system 200 in FIG. 2, respectively. I/O interface 824 may support any number of input devices such as a mouse, a touch screen, a microphone, a camera, a physical keyboard, a trackball, etc., and one or more output devices such as a speaker, a display, and/or the like. Additional I/O devices supported by I/O interface 824 are described below with respect to FIGS. 9 and 10.

User information 818 may include, without limitation, information regarding a user, a user's account (e.g., log in credentials, a user alias or handle, etc.), a user's client device, a user's network, titles played or viewed as a spectator by the user, user rewards earned, and/or indications of actions/activities in which users are engaged at client device 802. It is also contemplated herein that one or more portions of user information 224 of system 200 may also be included as part of user information 808. User information may be stored in memory 806.

One or more titles 820 and rewards 822 may include one or more portions of information as described for one or more titles and rewards information 222 of FIG. 2. Title(s) 820 and rewards 822 may be stored in memory 806 (e.g., as in a persistent storage or random access memory thereof). Title(s) 802 may include games, applications, etc., that are executable by processor 804. Rewards 822 may include rewards to be issued for users that play title(s) 822 and rewards for spectators of content streams of title(s) 822. Rewards 822 may be, but are not limited to, badges, skins, in-game items, experience points, in-game unlocks, and/or the like, to be issued by title(s) 820 via system 800.

Client manager 808 includes a plurality of components for performing the techniques described herein for enhancements in live video content streams and managing rewards. Client manager 808 may comprise a software development kit (SDK) that wraps up a cloud entry point for a rewards service as described herein. Such an SDK may be configured to specifically communicate with the rewards service such that title developers are not required to develop and/or maintain their own external services. As shown, client manager 808 includes a communicator 810, a streaming manager 812, a spectator manager 814, and a UI manager 816. While shown separately for illustrative clarity, in embodiments, one or more of communicator 810, streaming manager 812, spectator manager 814, and/or UI manager 816 may be combined together and/or as a part of other components of system 800. In some embodiments, less than all of the components of client manager 808 and/or client device 802 illustrated in FIG. 8 may be included. In software implementations, one or more components of client manager 808 and/or client device 802 may be stored in memory 806 and may be executed by processor 804.

Communicator 810 may be similarly configured as communicator 210 of system 200 in FIG. 2. Streaming manager 812 is configured to manage the streaming of titles from client device 802, and spectator manager 814 is configured to manage the viewing of content streams for titles by spectators from client device 802.

UI manager 816 is configured to manage one or more UIs utilized by system 800, such as UIs similar to UI 112a and/or UI 112b in FIG. 1, etc. UIs of UI manager 816 may be any type of service/application UI, browser, client or electronic communication application, messaging application, portal, and/or the like.

For instance, a spectator user of client device 802 may be enabled to interact with a spectator selection UI to browse titles for viewing content streams. Options in a spectator selection UI may be grouped or sorted by title name, genre, favorites, other users the spectator follows, most viewed, and/or the like. An option that is selected from a spectator selection UI may cause spectating manager 814 to execute and perform operations that allow the spectator to view the selected content stream. As an example, spectating manager 814 may be executed to send a network communication to system 200 as shown in step 516 of flow diagram 500 of FIG. 5. Spectator selection UIs may be title-specific, in embodiments. Additionally, spectator selection UIs may include interactive spectating features that enable a spectator to interact with a content stream being viewed.

Similarly, a user of client device 802 may be enabled to interact with a streamer selection UI to browse titles for playing and streaming. Options in a streamer selection UI may be grouped or sorted by title name, genre, favorites, other users the spectator follows, most viewed, and/or the like. An option that is selected from a streamer selection UI may cause streaming manager 812 to execute and perform operations that allow the user to play and stream a title that may be viewed by spectators to earn rewards. As an example, streaming manager 812 may be executed to send a network communication to system 200 as shown in step 510 of flow diagram 500 of FIG. 5. Streamer selection UIs may be title-specific, in embodiments.

A rewards UI may also be included for UI manager 816. Rewards UIs may include indications of rewards earned and/or rewards that are available to redeem that a spectator has earned. Rewards in rewards UIs may be grouped or sorted by title name, genre, favorites, other users the spectator follows, most viewed streams, most earned rewards, by time earned, and/or the like.

In some embodiments a rewards service host system, e.g., system 200, may also be configured as a streamer client device. For instance, a rewards service host system may execute titles to be played by users, may enable the streaming of titles executed thereby, and/or may enable the viewing of titles executed thereby for spectators. Accordingly, any components, operations, and/or functionality of client devices described herein may also be attributed to rewards service host systems.

### III. Example Mobile Device and Computing Device Embodiments

Embodiments described herein may be implemented in hardware, or hardware combined with software and/or firmware. For example, embodiments described herein may be implemented as computer program code/instructions configured to be executed in one or more processors and stored in a computer readable storage medium. Alternatively, embodiments described herein may be implemented as hardware logic/electrical circuitry.

As noted herein, the embodiments described, including system 100 of FIG. 1, system 200 of FIG. 2, subsystem 600 of FIG. 6, and system 800 of FIG. 8, along with any components and/or subcomponents thereof, as well as the flowcharts/flow diagrams described herein and/or further examples described herein, may be implemented in hardware, or hardware with any combination of software and/or firmware, including being implemented as computer program code configured to be executed in one or more processors and stored in a computer readable storage medium, or being implemented as hardware logic/electrical circuitry, such as being implemented together in a system-on-chip (SoC), a field programmable gate array (FPGA), or an application specific integrated circuit (ASIC). A SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

Embodiments described herein may be implemented in one or more computing devices similar to a mobile system and/or a computing device in stationary or mobile computer embodiments, including one or more features of mobile systems and/or computing devices described herein, as well as alternative features. The descriptions of mobile systems and computing devices provided herein are provided for purposes of illustration, and are not intended to be limiting. Embodiments may be implemented in further types of computer systems, as would be known to persons skilled in the relevant art(s).

FIG. 9 is a block diagram of an exemplary mobile system 900 that includes a mobile device 902 that may implement embodiments described herein. For example, mobile device 902 may be used to implement any system, client, or device, or components/subcomponents thereof, in the preceding sections. As shown in FIG. 9, mobile device 902 includes a variety of optional hardware and software components. Any component in mobile device 902 can communicate with any other component, although not all connections are shown for ease of illustration. Mobile device 902 can be any of a variety of computing devices (e.g., cell phone, smart phone, handheld computer, Personal Digital Assistant (PDA), etc.) and can allow wireless two-way communications with one or more mobile communications networks 904, such as a cellular or satellite network, or with a local area or wide area network.

Mobile device 902 can include a controller or processor 910 (e.g., signal processor, microprocessor, ASIC, or other control and processing logic circuitry) for performing such tasks as signal coding, data processing, input/output processing, power control, and/or other functions. An operating system 912 can control the allocation and usage of the components of mobile device 902 and provide support for one or more application programs 914 (also referred to as “applications” or “apps”). Application programs 914 may include common mobile computing applications (e.g., e-mail applications, calendars, contact managers, web browsers, messaging applications) and any other computing applications (e.g., word processing applications, mapping applications, media player applications).

Mobile device 902 can include memory 920. Memory 920 can include non-removable memory 922 and/or removable memory 924. Non-removable memory 922 can include RAM, ROM, flash memory, a hard disk, or other well-known memory devices or technologies. Removable memory 924 can include flash memory or a Subscriber Identity Module (SIM) card, which is well known in GSM communication systems, or other well-known memory devices or technologies, such as “smart cards.” Memory 920 can be used for storing data and/or code for running operating system 912 and application programs 914. Example data can include web pages, text, images, sound files, video data, or other data to be sent to and/or received from one or more network servers or other devices via one or more wired or wireless networks. Memory 920 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

A number of programs may be stored in memory 920. These programs include operating system 912, one or more application programs 914, and other program modules and program data. Examples of such application programs or program modules may include, for example, computer program logic (e.g., computer program code or instructions) for implementing one or more of system 100 of FIG. 1, system 200 of FIG. 2, subsystem 600 of FIG. 6, and system 800 of FIG. 8, along with any components and/or subcomponents thereof, as well as the plots and flowcharts/flow diagrams and/or further examples described herein.

Mobile device 902 can support one or more input devices 930, such as a touch screen 932, a microphone 934, a camera 936, a physical keyboard 938 and/or a trackball 940 and one or more output devices 950, such as a speaker 952 and a display 954. Other possible output devices (not shown) can include piezoelectric or other haptic output devices. Some devices can serve more than one input/output function. For example, touch screen 932 and display 954 can be combined in a single input/output device. Input devices 930 can include a Natural User Interface (NUI).

One or more wireless modems 960 can be coupled to antenna(s) (not shown) and can support two-way communications between processor 910 and external devices, as is well understood in the art. Modem 960 is shown generically and can include a cellular modem 966 for communicating with the mobile communication network 904 and/or other radio-based modems (e.g., Bluetooth 964 and/or Wi-Fi 962). At least one wireless modem 960 is typically configured for communication with one or more cellular networks, such as a GSM network for data and voice communications within a single cellular network, between cellular networks, or between the mobile device and a public switched telephone network (PSTN).

Mobile device 902 can further include at least one input/output port 980, a power supply 982, a satellite navigation system receiver 984, such as a Global Positioning System (GPS) receiver, an accelerometer 986, and/or a physical connector 990, which can be a USB port, IEEE 1394 (FireWire) port, and/or RS-232 port. The illustrated components of mobile device 902 are not required or all-inclusive, as any components can be deleted and other components can be added as would be recognized by one skilled in the art.

In an embodiment, mobile device 902 is configured to implement any of the above-described features of flowcharts herein. Computer program logic for performing any of the operations, steps, and/or functions described herein may be stored in memory 920 and executed by processor 910.

FIG. 10 depicts an exemplary implementation of a computing device 1000 in which embodiments may be implemented. For example, embodiments described herein may be implemented in one or more computing devices similar to computing device 1000 in stationary or mobile computer embodiments, including one or more features of computing device 1000 and/or alternative features. The description of computing device 1000 provided herein is provided for purposes of illustration, and is not intended to be limiting. Embodiments may be implemented in further types of computer systems and/or game consoles, etc., as would be known to persons skilled in the relevant art(s).

As shown in FIG. 10, computing device 1000 includes one or more processors, referred to as processor circuit 1002, a system memory 1004, and a bus 1006 that couples various system components including system memory 1004 to processor circuit 1002. Processor circuit 1002 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 1002 may execute program code stored in a computer readable medium, such as program code of operating system 1030, application programs 1032, other programs 1034, etc. Bus 1006 represents one or more of any of several types of bus structures, including a memory bus or memory controller, a peripheral bus, an accelerated graphics port, and a processor or local bus using any of a variety of bus architectures. System memory 1004 includes read only memory (ROM) 1008 and random access memory (RAM) 1010. A basic input/output system 1012 (BIOS) is stored in ROM 1008.

Computing device 1000 also has one or more of the following drives: a hard disk drive 1014 for reading from and writing to a hard disk, a magnetic disk drive 1016 for reading from or writing to a removable magnetic disk 1018, and an optical disk drive 1020 for reading from or writing to a removable optical disk 1022 such as a CD ROM, DVD ROM, or other optical media. Hard disk drive 1014, magnetic disk drive 1016, and optical disk drive 1020 are connected to bus 1006 by a hard disk drive interface 1024, a magnetic disk drive interface 1026, and an optical drive interface 1028, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 1030, one or more application programs 1032, other programs 1034, and program data 1036. Application programs 1032 or other programs 1034 may include, for example, computer program logic (e.g., computer program code or instructions) for implementing embodiments described herein, such as system 100 of FIG. 1, system 200 of FIG. 2, subsystem 600 of FIG. 6, and system 800 of FIG. 8, along with any components and/or subcomponents thereof, as well as the plots and flowcharts/flow diagrams described herein and/or further examples described herein.

A user may enter commands and information into the computing device 1000 through input devices such as keyboard 1038 and pointing device 1040. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 1002 through a serial port interface 1042 that is coupled to bus 1006, but may be connected by other interfaces, such as a parallel port, game port, or a universal serial bus (USB).

A display screen 1044 is also connected to bus 1006 via an interface, such as a video adapter 1046. Display screen 1044 may be external to, or incorporated in computing device 1000. Display screen 1044 may display information, as well as being a user interface for receiving user commands and/or other information (e.g., by touch, finger gestures, virtual keyboard, etc.). In addition to display screen 1044, computing device 1000 may include other peripheral output devices (not shown) such as speakers and printers.

Computing device 1000 is connected to a network 1048 (e.g., the Internet) through an adaptor or network interface 1050, a modem 1052, or other means for establishing communications over the network. Modem 1052, which may be internal or external, may be connected to bus 1006 via serial port interface 1042, as shown in FIG. 10, or may be connected to bus 1006 using another interface type, including a parallel interface.

As used herein, the terms “computer program medium,” “computer-readable medium,” and “computer-readable storage medium,” etc., are used to refer to physical hardware media such as the hard disk associated with hard disk drive 1014, removable magnetic disk 1018, removable optical disk 1022, other physical hardware media such as RAMs, ROMs, flash memory cards, digital video disks, zip disks, MEMs, nanotechnology-based storage devices, and further types of physical/tangible hardware storage media (including memory 1020 of FIG. 10). Such computer-readable media and/or storage media are distinguished from and non-overlapping with communication media and propagating signals (do not include communication media and propagating signals). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media that are separate and non-overlapping with embodiments directed to computer-readable storage media.

As noted above, computer programs and modules (including application programs 1032 and other programs 1034) may be stored on the hard disk, magnetic disk, optical disk, ROM, RAM, or other hardware storage medium. Such computer programs may also be received via network interface 1050, serial port interface 1042, or any other interface type. Such computer programs, when executed or loaded by an application, enable computing device 1000 to implement features of embodiments discussed herein. Accordingly, such computer programs represent controllers of the computing device 1000.

Embodiments are also directed to computer program products comprising computer code or instructions stored on any computer-readable medium or computer-readable storage medium. Such computer program products include hard disk drives, optical disk drives, memory device packages, portable memory sticks, memory cards, and other types of physical storage hardware.

### IV. Additional Example and Advantages

As described, systems and devices embodying the techniques herein may be configured and enabled in various ways to perform their respective functions. In embodiments, one or more of the steps or operations of any flowchart and/or flow diagram described herein may not be performed. Moreover, steps or operations in addition to or in lieu of those in any flowchart and/or flow diagram described herein may be performed. Further, in examples, one or more operations of any flowchart and/or flow diagram described herein may be performed out of order, in an alternate sequence, or partially (or completely) concurrently with each other or with other operations.

According to the described embodiments, a logged-in spectator can be rewarded for watching gameplay of a title via content stream, and rewards are earned without sharing personal user information with the title, the streamer client device, or the title developer. Rewards are also issued for interacting with a title and making decisions during content streams, and spectators are informed when the title being played and streamed offers rewards, thus the spectators knows when a reward is received. The described rewards services may be configured to implement a secured write mode which will require a secret to be provided for any write or reward redemption calls to the service. This mode prevents user accounts from directly calling a rewards service for a title to provide a better measure of security around rewards. For instance, when this secured write mode is enabled, an authorized request on behalf of a user may be made to the rewards service, however this call will not be able to redeem rewards without provision of the secret.

Title developers are enabled to easily grant rewards for all viewers that have viewed, or are viewing, content stream based on criteria for the rewards that are maintained by the title. Title developers are also enabled to grant rewards to specific viewers for specific criteria being met. Additionally, title developers are not required to perform extensive service configurations and maintenance to implement rewards, and through a central rewards service, title developers can reward users for watching any versions of any titles.

The particular arrangement and location of the described reward service hosts and system is a technical improvement over the current state of the art for handling content streams and rewards management. As noted above, current solutions require user to share personal and identification information with different developer services thus raising privacy concerns, and are inefficient with respect to network, storage, and power resource usage. The embodiments herein provide for versatile reward services that are centrally located and scalable for access by users that play and stream titles as well as spectators, and maintain user privacy—that is, the described reward service hosts and systems are adaptable to many different users and title rewards preferences while also being installed remotely in a single, accessible location. Dynamic and efficient content stream and rewards management that is technology-based is thus described and enabled. Therefore, the described embodiments improve the technological process for content streams and rewards management at least through the non-conventional and non-generic arrangement of the hosts and systems herein.

Furthermore, the described embodiments do not exist in software implementations for rewards management, e.g., in cloud-based implementations. Still further, real-time information for rewards earned while viewing a content stream are provided to spectators via UIs, e.g., as notifications, messages, alerts, icons, etc., thus improving the spectator UI functionality. Additionally, spectators are able to view, via the spectator UI, a reward issued by a title for the title without yet having executed the title for play to redeem the reward.

The additional examples and embodiments described in this Section may be applicable to examples disclosed in any other Section or subsection of this disclosure.

A system is described herein. The system may be configured and enabled in various ways to enhance live video content streams and manage reward notifications, determinations, and grants, as described herein. The system includes one or more processors and one or more memories that store program code to be executed by the processor. The program code includes a spectator tracker, a time tracker, a rewards determiner, and a rewards issuer. The spectator tracker is configured to track spectators logged in and viewing a content stream of a title at respective spectator client devices, the content stream streamed over a network from a streamer client device executing the title. The time tracker is configured to track a time spent viewing the streamed content stream for each of the spectators. The rewards determiner is configured to receive an indication from the streamer client device of a reward for issue associated with the title, and determine one or more of the spectators having met criteria for the reward. The rewards issuer is configured to issue a communication notice indicative of the reward to spectator client devices corresponding to the determined one or more spectators.

In the system, the rewards issuer comprises an application programming interface (API) that is configured to cause the communication notice to be issued to the spectator client devices corresponding to the determined one or more spectators as a single multi-cast communication.

In the system, the rewards issuer is configured to issue in real-time the communication notice to the spectator client devices corresponding to the determined one or more spectators.

In the system, the criteria comprise at least one of a total amount of time spent by a spectator viewing the content stream, a total amount of time spent by a spectator viewing the content stream and at least one previous content stream, a number of rewards a spectator has previously been granted for the title, a number of times a spectator has viewed content streams of the title, interactive participation in the content stream by a spectator while viewing the content stream, or occurrence of a pre-determined event while a spectator views the content stream.

In an embodiment of the system, the program code further comprises a spectator authenticator that is configured to receive an authentication request from a spectator client device of a spectator, and authenticate the spectator as being a spectator-player of the title. In the embodiment, the rewards issuer is configured to issue a notification of one or more stored rewards to the spectator client device of the spectator-player to enable the spectator-player to redeem the one or more stored rewards.

In an embodiment of the system, the program code further comprises a spectator data manager that is configured to store identification information for players and spectators of titles, and store rewards for which criteria are met for the spectators. In the embodiment, the rewards issuer is configured to determine stored rewards for the spectator-player in response to a reward request received from the spectator client device of the spectator-player, and issue an indication of the determined stored rewards to the spectator client device of the spectator-player.

In an embodiment of the system, the title is integrated with the rewards system by a title configuration operation, and the spectator tracker is configured to track spectators logged in and viewing an additional content stream of an unintegrated title at respective spectator client devices, the additional content stream streamed over the network from a streamer client device that executes the unintegrated title. In the embodiment, the time tracker is configured to track time spent viewing for each of spectator logged in and viewing the streamed additional content stream.

In an embodiment of the system, the reward issuer is configured to generate an earn rewards notification for at least one of the spectators, the earn rewards notification providing information that one or more rewards for spectating are available to be earned for the title, and issue the earn rewards notification to the at least one of the spectators prior to their viewing of the content stream.

A method for a title rewards service executing on a processing system is also described herein. The method may be for enhancing live video content streams and managing reward notifications, determinations, and grants, as described herein. The method includes tracking a time spent viewing for each of one or more spectators at respective client devices during a content stream of a title that is executed by a remote streamer client device and streamed over a network, and receiving an indication from the streamer client device of a reward for issue associated with the title. The method further includes determining one or more spectators having met criteria for the reward, and issuing a communication notice indicative of the reward to spectator client devices of the determined one or more spectators.

In an embodiment of the method, said issuing the communication notice comprises causing the communication notice to be issued to via an application programming interface (API) to the spectator client devices of the determined one or more spectators as a single multi-cast communication.

In an embodiment of the method, the communication notice is issued in real-time to the spectator client devices corresponding to the determined one or more spectators.

In an embodiment of the method, the criteria comprise at least one of a total amount of time spent by a spectator viewing the content stream, a total amount of time spent by a spectator viewing the content stream and at least one previous content stream, a number of rewards a spectator has previously been granted for the title, a number of times a spectator has viewed content streams of the title, interactive participation in the content stream by a spectator while viewing the content stream, or occurrence of a pre-determined event while a spectator views the content stream.

In an embodiment, the method further comprises receiving an authentication request from a spectator client device, authenticating the spectator as being a spectator-player of the title, and issuing a notification of one or more stored rewards to the spectator client device of the spectator-player to enable the spectator-player to redeem the one or more stored rewards.

In the embodiment, the method further comprises storing identification information for players and spectators of titles, storing rewards for which criteria are met for the spectators, and determining stored rewards for the spectator-player in response to a reward request received from the spectator client device of the spectator-player or in response to a predetermined period of time since said authenticating the spectator-player.

In an embodiment, the method further comprises generating an earn rewards notification that provides information that one or more rewards for spectating are available to be earned for the title, receiving a spectating request, for viewing the content stream over the network, from a spectator client device of a spectator that is logged in to the title rewards service, and issuing the earn rewards notification to at least one of the spectators prior to their viewing of the content stream.

Another system is also described herein. The system may be configured and enabled in various ways to enhance live video content streams and manage reward notifications, determinations, and grants, as described herein. The system includes one or more processors and one or more memories that stores program code to be executed by the processor. The program code includes a title manager, a spectator tracker, and a time tracker. The title manager is configured to associate a title identifier with a title executed by a streamer client device of a title streamer logged into the rewards system, the title being an unintegrated title without rewards granting configured. The spectator tracker is configured to track spectators logged in and viewing a content stream of the title at respective spectator client devices, the content stream streamed by the streamer client device over a network. The time tracker is configured to track a time spent viewing the streamed content stream for each of the spectators.

In an embodiment of the system, the title manager is configured to receive an integration configuration command associated with a title developer for the title, execute the integration configuration command for the title, and denote the title as being an integrated title.

In the embodiment, the program code further comprises a rewards determiner that is configured to receive an indication from the streamer client device of a reward for issue associated with the integrated title, and determine one or more of the spectators having met criteria for the reward. In the embodiment, the program code further comprises a rewards issuer configured to issue a communication notice indicative of the reward to spectator client devices corresponding to the determined one or more spectators.

In an embodiment, the program code further comprises a rewards determiner configured to receive an indication from the streamer client device of a reward for the issue associated with the integrated title, and determine retroactively, subsequent to the integration configuration command being executed, that one or more spectators have met criteria for the reward based on a time spent viewing. In an embodiment of the system, the program code further comprises a rewards issuer configured to issue a communication notice indicative of the reward to spectator client devices corresponding to the determined one or more spectators.

In an embodiment of the system, the program code further comprises a spectator authenticator that is configured to receive an authentication request from a spectator client device of a spectator, and authenticate the spectator as being a spectator-player of the title. In the embodiment, the rewards issuer is configured to provide a notification of one or more stored rewards to the spectator client device of the spectator-player to enable the spectator-player to redeem the one or more stored rewards.

### V. Conclusion

While various embodiments of the disclosed subject matter have been described above, it should be understood that they have been presented by way of example only, and not limitation. It will be understood by those skilled in the relevant art(s) that various changes in form and details may be made therein without departing from the spirit and scope of the embodiments as defined in the appended claims. Accordingly, the breadth and scope of the disclosed subject matter should not be limited by any of the above-described exemplary embodiments, but should be defined only in accordance with the following claims and their equivalents.

1. A rewards system in a server, comprising:
at least one memory configured to store program code;
at least one processor configured to execute the program code, the program code including:
a spectator tracker configured to track spectators logged in and viewing a content stream of a title at respective spectator client devices, the content stream streamed over a network from a streamer client device, remote to the rewards system, executing the title;
a time tracker configured to track a time spent viewing the streamed content stream for each of the spectators;
a rewards determiner configured to
receive an indication over the network from the streamer client device of a reward for issue associated with the title, and
determine one or more of the spectators having met criteria for the reward; and
a rewards issuer configured to
issue a communication notice indicative of the reward to spectator client devices corresponding to the determined one or more spectators to enable collection of the award at the spectator client devices corresponding to the determined one or more spectators.

2. The rewards system of claim 1, wherein the rewards issuer comprises an application programming interface (API) that is configured to cause the communication notice to be issued to the spectator client devices corresponding to the determined one or more spectators as a single multi-cast communication.

3. The rewards system of claim 1, wherein the rewards issuer is configured to issue in real-time the communication notice to the spectator client devices corresponding to the determined one or more spectators.

4. The rewards system of claim 1, wherein the criteria comprise at least one of:
a total amount of time spent by a spectator viewing the content stream;
a total amount of time spent by a spectator viewing the content stream and at least one previous content stream;
a number of rewards a spectator has previously been granted for the title;
a number of times a spectator has viewed content streams of the title;
interactive participation in the content stream by a spectator while viewing the content stream; or
occurrence of a pre-determined event while a spectator views the content stream.

5. The rewards system of claim 1, wherein the program code further comprises:
a spectator authenticator configured to:
receive an authentication request from a spectator client device of a spectator; and
authenticate the spectator as being a spectator-player of the title; and
wherein the rewards issuer is configured to:
issue a notification of one or more stored rewards to the spectator client device of the spectator-player to enable the spectator-player to redeem the one or more stored rewards.

6. The rewards system of claim 5, wherein the program code further comprises:
a spectator data manager configured to:
store identification information for players and spectators of titles, and
store rewards for which criteria are met for the spectators; and
the rewards issuer is configured to:
determine stored rewards for the spectator-player in response to a reward request received from the spectator client device of the spectator-player, and
issue an indication of the determined stored rewards to the spectator client device of the spectator-player.

7. The rewards system of claim 1, wherein the title is integrated with the rewards system by a title configuration operation; and
the spectator tracker is configured to:
track spectators logged in and viewing an additional content stream of an unintegrated title at respective spectator client devices, the additional content stream streamed over the network from a streamer client device that executes the unintegrated title, and
the time tracker is configured to:
track time spent viewing for each of spectator logged in and viewing the streamed additional content stream.

8. The rewards system of claim 1, wherein the reward issuer is configured to:
generate an earn rewards notification for at least one of the spectators, the earn rewards notification providing information that one or more rewards for spectating are available to be earned for the title; and
issue the earn rewards notification to the at least one of the spectators prior to their viewing of the content stream.

9. A method for a title rewards service executing on a processing system, the method comprising:
tracking a time spent viewing for each of one or more spectators at respective client devices during a content stream of a title that is executed by a remote streamer client device and streamed over a network;
receiving an indication from the remote streamer client device of a reward for issue associated with the title;
determining one or more spectators having met criteria for the reward; and
issuing a communication notice indicative of the reward to spectator client devices of the determined one or more spectators to enable collection of the award at the spectator client devices of the determined one or more spectators.

10. The method for the title rewards service of claim 9, wherein said issuing the communication notice comprises causing the communication notice to be issued to via an application programming interface (API) to the spectator client devices of the determined one or more spectators as a single multi-cast communication.

11. The method for the title rewards service of claim 9, wherein the communication notice is issued in real-time to the spectator client devices corresponding to the determined one or more spectators.

12. The method for the title rewards service of claim 9, wherein the criteria comprise at least one of:
a total amount of time spent by a spectator viewing the content stream;
a total amount of time spent by a spectator viewing the content stream and at least one previous content stream;
a number of rewards a spectator has previously been granted for the title;
a number of times a spectator has viewed content streams of the title;
interactive participation in the content stream by a spectator while viewing the content stream; or
occurrence of a pre-determined event while a spectator views the content stream.

13. The method for the title rewards service of claim 9, further comprising:
receiving an authentication request from a spectator client device;
authenticating the spectator as being a spectator-player of the title; and
issuing a notification of one or more stored rewards to the spectator client device of the spectator-player to enable the spectator-player to redeem the one or more stored rewards.

14. The method for the title rewards service of claim 13, further comprising:
storing identification information for players and spectators of titles;
storing rewards for which criteria are met for the spectators; and
determining stored rewards for the spectator-player in response to a reward request received from the spectator client device of the spectator-player or in response to a predetermined period of time since said authenticating the spectator-player.

15. The method for the title rewards service of claim 9, further comprising:
generating an earn rewards notification that provides information that one or more rewards for spectating are available to be earned for the title;
receiving a spectating request, for viewing the content stream over the network, from a spectator client device of a spectator that is logged in to the title rewards service; and
issuing the earn rewards notification to at least one of the spectators prior to their viewing of the content stream.

16. A rewards system comprising:
at least one memory configured to store program code;
at least one processor configured to execute the program code, the program code including:
a title manager configured to associate a title identifier with a title executed by a streamer client device, of a title streamer, remote to and logged into the rewards system, the title being an unintegrated title without rewards granting configured;
a spectator tracker configured to track spectators logged in and viewing a content stream of the title at respective spectator client devices, the content stream streamed by the streamer client device over a network; and
a time tracker configured to track a time spent viewing the streamed content stream for each of the spectators.

17. The rewards system of claim 16, wherein the title manager is configured to:
receive an integration configuration command associated with a title developer for the title;
execute the integration configuration command for the title; and
denote the title as being an integrated title.

18. The rewards system of claim 17, wherein the program code further comprises:
a rewards determiner configured to:
receive an indication from the streamer client device of a reward for issue associated with the integrated title, and
determine one or more of the spectators having met criteria for the reward; and
a rewards issuer configured to
issue a communication notice indicative of the reward to spectator client devices corresponding to the determined one or more spectators.

19. The rewards system of claim 17, wherein the program code further comprises:
a rewards determiner configured to:
receive an indication from the streamer client device of a reward for the issue associated with the integrated title; and
determine retroactively, subsequent to the integration configuration command being executed, that one or more spectators have met criteria for the reward based on a time spent viewing; and
a rewards issuer configured to:
issue a communication notice indicative of the reward to spectator client devices corresponding to the determined one or more spectators.

20. The rewards system of claim 16, wherein the program code further comprises:
a spectator authenticator configured to:
receive an authentication request from a spectator client device of a spectator; and
authenticate the spectator as being a spectator-player of the title; and
wherein the rewards issuer is configured to:
provide a notification of one or more stored rewards to the spectator client device of the spectator-player to enable the spectator-player to redeem the one or more stored rewards.
